(19) United States
(12) Patent Application Publication
(10) Pub. No.: US 2004/0163256 A1
(43) Pub. Date: Aug. 26, 2004

(54) Method for producing a light-alloy bearing bush with a rough external surface

(76) Inventors: Karlheinz Bing, Remseck (DE); Martin Ruhle, Stuttgart (DE); Fritz Warth, Stuttgart (DE); Frank Winger, Stuttgart (DE)

Correspondence Address: WILLIAM COLLARD, COLLARD & ROE, P.C., 1077 NORTHERN BOULEVARD, ROSLYN, NY, 11576, US

(21) Appl. No.: 10/481,947

(22) PCT Filed: Jun. 7, 2002
(86) PCT No.: PCT/DE02/02074

(30) Foreign Application Priority Data
Jun. 23, 2001 (DE) 101 30 416.1
Apr. 26, 2002 (DE) 102 18 714.2

(51) Int. Cl. B21K 1/76; B23P 17/00

(52) U.S. Cl. 29/898.054

(57) ABSTRACT

The aim of the invention is to produce a light-alloy bearing bush with a rough external surface. To achieve this, particles, which are subsequently surrounded in part by the molten melt, are applied to the surface of the casting mould. When the bearing bush is released from the mould, the particles remain in said bush and are subsequently removed from the bearing bush preform either mechanically or by being dissolved in liquid.

The invention relates to a method for producing a light-alloy bearing bushing having a rough external surface, for an internal combustion engine. Such a method is known from DE 19958185. There, the rough surface of the light-alloy bearing bushing is produced, during casting of the bearing bushing using the lost-foam process, in that the lost-foam casting model of the bearing bushing has an external particle layer with undercuts, which results in a corresponding undercut shape of the external surface of the cast bearing bushing. The rough surface of the bearing bushing is a prerequisite for the fact that a good connection between the bearing bushing and the integral casting material occurs during casting of the bearing bushing.

The invention concerns itself with the problem of making production of a bearing bushing having a rough external surface possible even when using chill casting or sand casting.

This problem is solved by means of a method according to claim 1. Advantageous further developments are the object of the dependent claims.

Fixation of the particles is understood to mean that the particles at least do not come loose from the casting mold under the effect of gravity, or float to the top when the melt is filled in. On the other hand, if possible, fixation should be selected to be only so weak that the partially surrounded particles easily come loose from the casting mold when the light-alloy bearing bushing is removed, particularly from a chill mold or a sheet-metal insert for a chill mold. It is particularly preferred if fixation of the particles in the casting mold takes place by means of core binders, which are usually used in the production of sand cores or sand molds.

Sand molds or inserts made of sand, even divided sand molds can also be used as the casting mold.

It has proven to be advantageous that a grain size of the particles in a range from 0.3 mm to 1.5 mm results in an increase in the specific surface, which is produced by many small undercuts in the particle mixture.

The rough surface does not necessarily have to be present over the entire surface of the bearing bushing, but rather can be restricted to partial regions.

The greatest diameter of the bearing bushing is determined, in the rough region, by the inside diameter of the chill mold or the chill mold insert to which the particles have been applied. During casting, each particle is imaged as a depression, i.e. as a location with a lesser diameter, with reference to the outside diameter of the bearing bushing. Since the particles are accessible from the outside diameter after the bearing bushing has been removed from the mold, they can be dissolved in a liquid or can be removed from the bearing bushing mechanically, for example by means of sand blasting. In place of the particles that have been removed, depressions remain in the outside diameter of the bearing bushing blanks.

It is advantageous if the particles consist of salt, as it is also known for the production of salt cores for cooling channels.

The invention will be explained in greater detail below, using a bearing bushing produced according to the invention. The drawing shows:

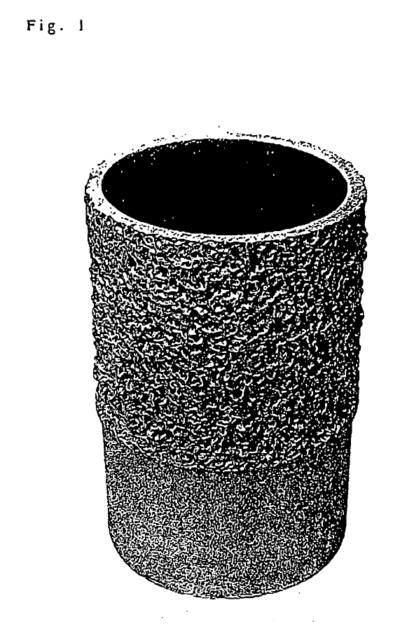

FIG. 1 a bearing bushing having a rough surface in the top region.

The bearing bushing has a fissured surface on the upper approximately 60% of its length, which has been formed by salt particles that were partially surrounded by the molten metal and subsequently dissolved out. In the lower region of the bearing bushing, which has a slightly lesser diameter due to the use of a corresponding chill mold insert, the bearing bushing is comparatively smooth.

1. Method for producing a light-alloy bearing bushing for internal combustion engines, having a rough external surface,
characterized in that
particles of a temperature-resistant substance are adhesively fixed in place on the surface of a casting mold or a casting mold insert for the production of the bearing bushing, whereby the particle size is preferably 0.3 to 1.5 mm, subsequently the light-alloy bearing bushing is cast in this casting mold or in this casting mold insert, the blank is removed from the casting mold or the casting mold insert with the particles, and the particles are removed from the bearing bushing blank.

2. Method for producing a light-alloy bearing bushing according to claim 1,
characterized in that
the particles are removed from the bearing bushing blank by being dissolved in a liquid.

3. Method according to claim 2,
characterized in that
the liquid is a solvent based on water.
